(19) United States
(12) Patent Application Publication
(10) Pub. No.: US 2002/0098136 A1
(43) Pub. Date: Jul. 25, 2002

(54) Device for staged addition of heat to a reactor

(76) Inventor: Nicholas Vanderborgh, Arvada, CO (US)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/767,456

(22) Filed: Jan. 23, 2001

(51) Int. Cl. B01J 8/02; B01J 35/02

(52) U.S. Cl. 422/220; 422/217

(57) ABSTRACT

Many useful chemical conversion processes result in the production or removal of thermal energy as the result of such processes. A device for permitting staged addition of heat into a steam reforming, carbon dioxide reforming, water-gas-shift, or preferential reactor using an inline system built to accomplish multiple reactant injection and gas mixing along the flow path of a chemical reactor. This integrates a uniform reaction injection device, a gas mixing component, and a catalytic initiator within a section designed to be installed between compartments used to promote an endothermic process. The intent is to provide heat through an endothermic process that uniformly increases temperature for convection heat transport into the subsequent compartment.

### FIELD OF THE INVENTION

The present invention relates to a device for permitting staged addition of heat into a steam reforming, carbon dioxide reforming, water-gas-shift, or preferential reactor using an inline system built to accomplish multiple reactant injection and gas mixing along the flow path of a chemical reactor.

### BACKGROUND OF THE INVENTION

Many useful chemical conversion processes result in the production or removal of thermal energy as the result of such processes. Processes that generate thermal energy (heat) are known as “exothermic”. Useful reactions that consume thermal energy know as “endothermic”. The speed of a chemical process, that process' “reaction rate”, varies with temperature. Such variation has been studied for decades. Even so some details of the cause for such variation remain obscure. Exothermic reactions generate heat. The heat is a result that some part of the energy contained in the reactants is converted to heat. In such a case the energy of the products contains less energy than the reactants-the difference is, in part, the heat released.

The heat produced flows into the local reaction environment. That environment includes the reactants and products and other local constituents. Specific agents known as catalysts promote many reactions. Because the reactions occur on such specific agents, catalysts also during exothermic reactions gain thermal energy, increasing in temperature. Generally, catalysts that are hotter promote reactions faster. In most cases such reactions result in high conversion rates as a result of this positive kinetic feed back. So-called “hot spot reactors” are an example of this behavior.

rates as a result of this positive kinetic feed back. So-called “hot spot reactors” are an example of this behavior.

Endothermic reactions follow different dynamics. In this case, heat is removed from the surrounding environment to supply the necessary reaction energy. The heat removed is essentially the difference between energy in the reactants and energy in the products. The reaction process consumes heat, cooling the surrounding environment, including any specific catalysts. Generally, catalysts react less quickly when cold. Also, generally, at some lower temperature the reaction will no longer have a useful conversion rate. The heat removal step is the result of the chemical process. When the reaction stops the cooling process stops as well. Consequently the cooling process does not extend continuously, but just to that temperature where the reaction rate is negligible. Therefore such a case could be described better as a “cool spot” reactor rather than a “cold spot” reactor.

To counter this tendency to cool and thus stop reactivity, endothermic reactions require continuous heat input. Heat is added either as a result of conduction or of convection. “Conduction” refers to heat flow from an internal or external heater through solid reactor constituents while “convection” means heat earned by a flow fluid, such as a gaseous reaction mixture. In practice both of these processes contribute to heat flow. Endothermic reactions are typically limited by the speed of such heat flow. Many previous examples of reactor designs show ways to accelerate the rate of heat addition.

### SUMMARY OF THE INVENTION

The present invention addresses a novel approach designed to incorporate exothermic features into an endothermic reactor design to improve conversion conditions.

This invention describes a hardware component that integrates a uniform reaction injection device, a gas mixing component, and a catalytic initiator within a section designed to be installed between compartments used to promote an endothermic process. The intent is to provide heat through an endothermic process that uniformly increases temperature for convection heat transport into the subsequent compartment.

### DETAILED DESCRIPTION OF PREFERRED EMBODIMENT

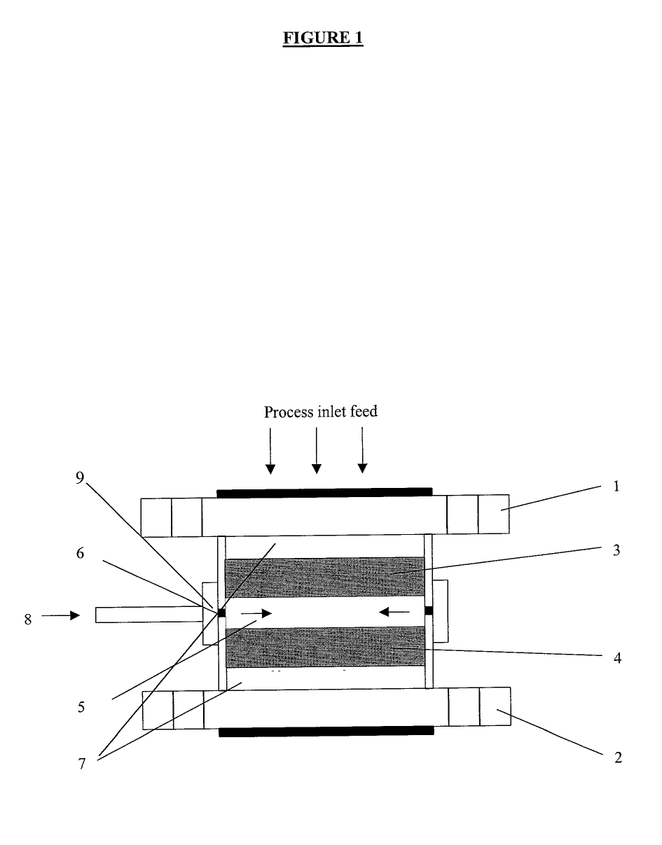

FIG. 1 shows an in-line injection component for adding thermal energy to promote specific reaction types.

The component is formed from steel or other material suitable to contain the reaction environment. Two flanges, 1 and 2, with appropriate gasket seals, are welded into a short tube section. Two pieces of appropriate porous material, 3 and 4, are inserted into the tube and sealed to force flow through the two porous materials. A flow distribution matrix, 5, is inserted into the space between the two porous materials, designed to facilitate mixing. The reactant feed, 8, is fed into a manifold, 9, welded onto the outside of the tube. This manifold opens into the tube interior through a series of holes, 6, drilled through the tube. Such holes direct the reactant feed gas uniformly into the flow distribution matrix. A catalyst applied as a layer formed on the lower surface of porous media, 4, or as a wire screen or mesh or as a small section of catalysts in pelletized forms are positioned after the second porous media, 4.

Such a component most likely will be inserted repeatedly within a reactor traverse. This is so because the technical goal is high conversion of the process feed stream, and that only occurs in those zones maintained at appropriate temperature. In order to accomplish this goal a catalyst with a high reaction rate will be selected. Such a catalyst will also remove heat at a high rate. Consequently most of the heat inserted into the process feed stream will be removed in a short traverse. Therefore following such short traverse another similar component is dictated.

In most situations the concentration of the process feed stream reactants decreases along the traverse of the reactor path. Because of this decrease the rate of reaction, as defined by the number of moles reacted per unit time, also decreases along that path. Less moles reacting results in less heat uptake. Consequently the quantity of reactant feed gas will be different along the multiply inserted injection components.

Several benefits can be realized with this device, including:

Reinjection of Reactants: Under some conditions, because of depletion along a reaction traverse, it makes sense to increase the concentration of one or more reactants. An example is to increase steam concentration in a water-gas-shift reactor. Additional reactant can be added in this way.

Injection of Heat: During reforming or other fuel processing oxygen or air can be injected. Such oxygen will be promptly reacted with part of the fuel, raising the local temperature of the reactor. This design results in heat generation within the flowing gas stream-direct contact heat exchange-in a two-dimension array. Such heating is far more effective than heating from the wall, especially in large diameter catalytic reactors.

Injection of heat with no consumption of reactants: At times fuels are not being processed so reaction with oxygen is not suitable. Under those conditions a mixture containing a fuel such as hydrogen and methanol and oxygen (air) can be added. That mixture will react on the exit catalyst causing heat injection. If the combustion rate of the added fuel is far larger than that of other constituents in the stream, the fuel consumes the greatest majority of the oxygen, leaving the composition of the stream relatively intact. Of course, the resulting stream includes the product, steam, as a constituent.

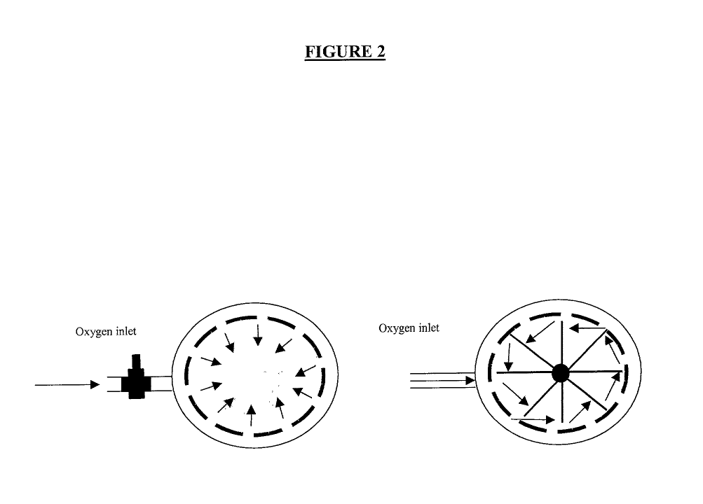

Thorough mixing is critical for this device to accomplish the goal of a planar heat wave throughout the entire flow volume. The requirement is to mix air with the process stream within a short flow traverse. Consequently mixing must be rapid; processes with depend on diffusion do not meet this criterion. Although there are many ways in which such mixing can be accomplished known to one trained in the art, two general embodiments are shown in FIG. 2. These are illustrated to suggest mixing approaches which can result in successful operation of this device.

FIG. 2 shows a part of mixing strategies. Oxygen feed gas is mixed into the process stream in the annular zone between the two porous structures in FIG. 1. Although many and diverse strategies for gas mixing are possible; two are shown to illustrate specific approaches to the mixing step. These two figures show a top view of the injection device. The left mixer operates by high-pressure air jets.

Air enters the device through a valve on the left-hand-side and flows into a pressured plenum connected to said mixer by a series of holes drilled through the outside of the primary reactor structure. High pressure is admitted periodically using the valve, which operates in a pulsed mode. Short pulses of high-pressure air traverse the mixing zone causing a turbulent mixing event. The second figure shows (right hand side) a similar design, but using a turbine convection mixer. Air is again fed into the feed air plenum and enters the mixer through holes drilled into the primary reactor structure. Such air streams are focused on the tips of the turbine blades, thereby transferring momentum to said blades causing the turbine to rotate, thus mixing the gases together. Such mixing is a forced convection-mixing event.

1. A chemical processing device specifically designed to be inserted along the traverse of a catalytic reactor comprising
an outer tube, two opposing flanges, 1 and 2, with appropriate gasket seals, such flanges being formed steel or other material suitable to contain the reaction environment;
two opposing pieces of porous material, 3 and 4, each adjacent to one of the said opposing flanges;
a flow distribution matrix, 5, between and adjacent to each said opposing pieces of porous material;
a reactant feed, 8, with attached manifold, 9, connected to said distribution matrix through a series of holes, in the outer tube; and
a catalyst layer formed on the surface of said porous material or on a wire mesh, palletized forms, or other appropriate means
